(19) United States
(12) Patent Application Publication
(10) Pub. No.: US 2012/0255309 A1
(43) Pub. Date: Oct. 11, 2012

(54) UTILIZING STEAM AND/OR HOT WATER GENERATED USING SOLAR ENERGY

(76) Inventors: MILTON VENETOS, Mountain View, CA (US); William Martin Conlon, Mountain View, CA (US)

(21) Appl. No.: 13/486,898

(22) Filed: Jun. 1, 2012

Related U.S. Application Data
(63) Continuation of application No. PCT/US2010/058571, filed on Dec. 1, 2010.
(60) Provisional application No. 61/265,721, filed on Dec. 1, 2009.

(51) Int. Cl. F03G 6/00; F01K 13/00; F01K 23/00; F02C 6/00

(52) U.S. Cl. 60/772; 60/645; 60/641.8; 60/676; 60/39.182

(57) ABSTRACT

Methods, systems, and apparatus by which steam and/or hot water generated using solar energy may be utilized to generate electricity or work are disclosed herein. A method in one instance may involve driving a first turbine using a fluid having energy obtained from a main energy source other than solar energy, and using solar energy-generated hot water and/or steam as an auxiliary energy input to drive the first turbine. An apparatus in one instance may include (1) a first turbine in fluid communication with and driven by a fluid heated by a main energy source other than solar energy in fluid communication with (2) a solar steam and/or hot water generator that utilizes solar energy to generate hot water and/or steam or other working fluid as an auxiliary energy input source for the first turbine.

### CROSS REFERENCE TO RELATED APPLICATIONS

This application is a Continuation of PCT/US2010/058571 filed Dec. 1, 2010 and entitled “Utilizing Steam and/or Hot Water Generated Using Solar Energy,” which claims the benefit of priority to U.S. App. Ser. No. 61/265,721 filed Dec. 1, 2009 and entitled “Utilizing Steam and/or Hot Water Generated Using Solar Energy.” All the above applications are incorporated herein for all purposes by reference in their entirety.

### FIELD OF THE INVENTION

The invention relates generally to the collection and utilization of solar energy.

### BACKGROUND

Additional sources of energy are needed to continue to supply an ever-increasing population and energy demand world-wide. Solar energy is readily available in certain geographic areas and can be used to generate electricity or provide heat for industrial and residential use. While solar energy may be converted directly to electricity with photovoltaic devices, for example, as an alternative solar energy may be collected as heat and converted to useful work. Solar energy collected as heat may be used, for example, to generate steam for use in electrical power generation or for other industrial processes.

### SUMMARY

Methods, systems, and apparatus are disclosed herein by which steam and/or hot water generated using solar energy may be utilized.

In one instance, a method of operating a solar power plant comprises generating at least hot water and/or steam using solar energy; driving a first turbine using a fluid having energy obtained from a main energy source other than solar energy, and using at least a portion of the hot water and/or steam generated using solar energy as an auxiliary energy input to drive the first turbine. Optionally, the method includes driving a solar steam turbine with solar energy-generated steam, and when the amount of steam generated with solar energy reaches or exceeds the normal operating capacity of the solar steam turbine, at least a portion of the excess steam generated using solar energy may be used as the auxiliary energy input driving the first turbine. The first turbine in any of these instances may be a steam turbine driven by steam heated by an energy source other than solar energy (e.g. natural gas combusted in a burner and used directly to heat the steam, exhaust gas from a combustion process in which some heat was previously extracted, other steam streams, etc.).

Hot water and/or steam generated using solar energy may be used to preheat feedwater for steam heated using an energy source other than solar energy. Alternatively or additionally, at least a portion of excess steam generated using solar energy may be mixed with a portion of the steam generated using energy from a source other than solar energy to drive the first turbine.

Further operational steps that may be incorporated in any of the methods above or herein include: (1) extracting from the solar steam turbine a portion of the steam driving the solar steam turbine; (2) preheating, with the extracted steam, feedwater from which is generated at least a portion of the steam driving the solar steam turbine; and (3) when the steam driving the solar steam turbine reaches or exceeds the normal operating capacity of the solar steam turbine, reducing the amount of steam extracted from the solar steam turbine for preheating feedwater. Of course, in any instance above or herein, hot water and/or steam generated using solar energy may be generated by heating water and/or steam using concentrated solar radiation (e.g. using a linear Fresnel array, trough, dish, or other solar thermal energy concentrator), and/or by heating a heat transfer fluid (e.g. an oil or other organic heat-exchange fluid) with solar energy, and transferring heat from the heat transfer fluid to water to generate the hot water and/or steam.

Further, in any instance discussed above or herein, an operational step of generating steam using an energy source other than solar energy may comprise generating this steam using hot exhaust from a combustion turbine, either directly or after some heat has been extracted from the hot exhaust in one or more previous operational steps.

In any instance above and herein, a fuel may be preheated using at least a portion of the hot water and/or steam generated by solar energy, and the preheated fuel may be combusted in a combustion turbine. The fuel preheating may optionally occur when the steam generated using solar energy is insufficient to drive the solar steam turbine. Other variations of the method and/or plant equipment as described below and in the appended claims may be implemented.

For instance, in one implementation, a method of operating a solar power plant comprises generating steam in a solar steam generator having a feedwater stream using solar energy, driving a steam turbine with at least a portion of the steam, extracting from the steam turbine a portion of the steam driving the turbine, and preheating the feedwater stream (prior to the step of generating steam) with the extracted steam. When the amount of steam driving the turbine reaches or exceeds the normal operating capacity of the turbine, the extraction of steam from the steam turbine for preheating the feedwater may be reduced or stopped entirely. In this instance, feedwater to the steam turbine may be preheated directly using e.g. solar energy rather than recycling steam from the steam turbine. This may, for example, utilize excess steam generated by the solar steam generator and provide an increased power output from the turbine resulting from an increased mass flow through the turbine.

In some variations of this method, when the steam driving the turbine reaches or exceeds the normal operating capacity of the turbine, another portion of the steam from the solar steam generator may be used to power a pump that pumps the feedwater. Alternatively, or in addition, when the steam driving the steam turbine reaches or exceeds the normal operating capacity of the turbine, another portion of the solar energy-generated steam may be used to power a chiller that cools an electric generator driven by the turbine. The chiller may be or comprise, for example, a mechanical vapor compression chiller and/or an absorption chiller.

In any of the above variations of this method, the steam may be generated directly from the feedwater, for example, by concentrating solar radiation onto a vessel or conduit containing the feedwater. Alternatively, or in addition, concentrated solar radiation may be used to heat a heat transfer fluid, and then heat from the heat transfer fluid may be transferred to the feedwater to generate the steam.

In another aspect, a method of operating a solar power plant comprises generating steam from feedwater using solar energy and driving a turbine with at least a portion of the steam. When the steam driving the turbine reaches or exceeds the normal operating capacity of the turbine, another portion of the steam is used to power a pump that pumps the feedwater. The steam may be generated directly from the feedwater, for example, by concentrating solar radiation onto a vessel or conduit containing the feedwater. Alternatively, or in addition, concentrated solar radiation may be used to heat a heat transfer fluid, and then heat from the heat transfer fluid may be transferred to the feedwater to generate the steam.

In another aspect, a method of operating a solar power plant comprises generating steam using solar energy, driving a turbine with at least a portion of the steam, and driving an electric generator with the turbine. When the steam driving the turbine reaches or exceeds the normal operating capacity of the turbine, another portion of the steam may be used to power a chiller that cools an electric generator driven by the turbine. The chiller may be or comprise, for example, a mechanical vapor compression chiller and/or an absorption chiller.

In another aspect, a method of operating a power plant comprises generating steam using solar energy, driving a first turbine with at least a portion of the steam generated using solar energy, generating steam using an energy source other than solar energy, and driving a second turbine with at least a portion of the steam generated using an energy source other than solar energy. When the steam driving the first turbine reaches or exceeds the normal operating capacity of the first turbine, another portion of the steam generated using solar energy is used to preheat feedwater from which is generated at least a portion of the steam driving the second turbine.

In some variations, this method may also comprise extracting from the first turbine a portion of the steam driving the first turbine and preheating, with the extracted steam, a feedwater stream from which is generated at least a portion of the steam driving the first turbine. When the steam driving the first turbine reaches or exceeds the normal operating capacity of the first turbine, the extraction of steam from the first turbine for preheating the feedwater is reduced or stopped entirely.

In any of the above variations of this method, the steam may be generated directly from the feedwater, for example, by concentrating solar radiation onto a vessel or conduit containing the feedwater. Alternatively, or in addition, concentrated solar radiation may be used to heat a heat transfer fluid, and then heat from the heat transfer fluid may be transferred to the feedwater to generate the steam.

In another aspect, a method of operating a power plant comprises generating steam using solar energy, driving a first turbine with at least a portion of the steam generated using solar energy, generating steam using an energy source other than solar energy, and driving a second turbine with at least a portion of the steam generated using an energy source other than solar energy. When the steam driving the first turbine reaches or exceeds the normal operating capacity of the first turbine, another portion of the steam generated using solar energy is mixed with the steam driving the second turbine.

In some variations, this method may also comprise extracting from the first turbine a portion of the steam driving the first turbine and preheating, with the extracted steam, a feedwater stream from which is generated at least a portion of the steam driving the first turbine. When the steam driving the first turbine reaches or exceeds the normal operating capacity of the first turbine, the extraction of steam from the first turbine for preheating the feedwater is reduced or stopped entirely.

In any of the above variations of this method, the steam may be generated directly from the feedwater, for example, by concentrating solar radiation onto a vessel or conduit containing the feedwater. Alternatively, or in addition, concentrated solar radiation may be used to heat a heat transfer fluid, and then heat from the heat transfer fluid may be transferred to the feedwater to generate the steam.

In another aspect, a method of operating a power plant comprises generating steam using solar energy, driving a first turbine with at least a portion of the steam generated using solar energy, operating a combustion turbine, generating steam using hot exhaust from the combustion turbine, and driving a third turbine with at least a portion of the steam generated using the hot exhaust from the combustion turbine. When the steam driving the first turbine reaches or exceeds the normal operating capacity of the first turbine, another portion of the steam generated using solar energy is mixed with steam driving the third turbine, with feedwater from which is generated steam driving the third turbine, or with both.

Some variations of this method may also comprise extracting from the first turbine a portion of the steam driving the first turbine and preheating, with the extracted steam, a feedwater stream from which is generated at least a portion of the steam driving the first turbine. When the steam driving the first turbine reaches or exceeds the normal operating capacity of the first turbine, the extraction of steam from the first turbine for preheating the feedwater is reduced or stopped entirely.

In any of the above variations of this method, the steam may be generated directly from the feedwater, for example, by concentrating solar radiation onto a vessel or conduit containing the feedwater. Alternatively, or in addition, concentrated solar radiation may be used to heat a heat transfer fluid, and then heat from the heat transfer fluid may be transferred to the feedwater to generate the steam.

In another aspect, a method of operating a power plant comprises generating hot water, steam, or hot water and steam using solar energy, preheating a fuel using at least a portion of the hot water, steam, or hot water and steam, and combusting the fuel in a combustion turbine. In some variations, the method may also comprise driving a second turbine with another portion of the steam. Some variations of this method may further comprise extracting from the second turbine a portion of the steam driving the second turbine and preheating, with the extracted steam, a feedwater stream from which is generated at least a portion of the steam driving the second turbine. When the steam driving the second turbine reaches or exceeds the normal operating capacity of the second turbine, the extraction of steam from the second turbine for preheating the feedwater is reduced or stopped entirely.

Some variations of this method may also comprise (in combination with any of the above variations of this method utilizing the second turbine) generating steam using hot exhaust from the combustion turbine, and driving a third turbine with at least a portion of the steam generated using the hot exhaust from the combustion turbine. When the steam driving the second turbine reaches or exceeds the normal operating capacity of the second turbine, another portion of the steam generated using solar energy is mixed with steam driving the third turbine, with feedwater from which is generated steam driving the third turbine, or with both.

In any of the above variations of this method, the hot water, steam, or hot water and steam may be generated directly from water, for example, by concentrating solar radiation onto a vessel or conduit containing the water. Alternatively, or in addition, concentrated solar radiation may be used to heat a heat transfer fluid, and then heat from the heat transfer fluid may be transferred to water to generate the steam.

In another aspect, a method of operating a power plant comprises generating hot water, steam, or hot water and steam using solar energy, driving a first turbine with at least a portion of the steam, and combusting a fuel in a combustion turbine. When the steam is insufficient to drive the first turbine, at least a portion of the hot water, steam, or hot water and steam is used to preheat at least a portion of the fuel prior to combusting the fuel in the combustion turbine.

In some variations, this method may also comprise, when the steam driving the first turbine reaches or exceeds the normal operating capacity of the first turbine, using at least a portion of the hot water, another portion of the steam, or both to preheat the fuel prior to combusting the fuel in the combustion turbine.

In some variations, this method may also comprise (in combination with any of the above variations of this method) extracting from the first turbine a portion of the steam driving the first turbine, and preheating, with the extracted steam, feedwater from which is generated at least a portion of the steam driving the first turbine. When the steam driving the first turbine reaches or exceeds the normal operating capacity of the first turbine, the extraction of steam from the first turbine for preheating the feedwater is reduced or stopped entirely.

In another variation this method may also comprise (in combination with any of the above variations of this method) generating steam using hot exhaust from the combustion turbine, and driving a third turbine with at least a portion of the steam generated using the hot exhaust from the combustion turbine. When the steam driving the first turbine reaches or exceeds the normal operating capacity of the first turbine, another portion of the steam generated using solar energy is mixed with steam driving the third turbine, with feedwater from which is generated steam driving the third turbine, or with both.

In any of the above variations of this method, the hot water, steam, or hot water and steam may be generated directly from water, for example, by concentrating solar radiation onto a vessel or conduit containing the water. Alternatively, or in addition, concentrated solar radiation may be used to heat a heat transfer fluid, and then heat from the heat transfer fluid may be transferred to water to generate the steam.

In another aspect, a method of operating a power plant comprises generating steam or hot water and steam using solar energy, driving a first turbine with at least a portion of the steam, and operating a combustion turbine. When the steam driving the first turbine reaches or exceeds the normal operating capacity of the first turbine, at least a portion of the hot water, another portion of the steam, or both are used to preheat a fuel prior to combusting the fuel in the combustion turbine.

In some variations this method comprises extracting from the first turbine a portion of the steam driving the first turbine and preheating, with the extracted steam, feedwater from which is generated at least a portion of the steam driving the first turbine. When the steam driving the first turbine reaches or exceeds the normal operating capacity of the first turbine, the extraction of steam from the first turbine for preheating feedwater is reduced or stopped entirely.

In some variations this method may also comprise (in combination with any of the above variations of this method) generating steam using hot exhaust from the combustion turbine, and driving a third turbine with at least a portion of the steam generated using the hot exhaust from the combustion turbine. When the steam driving the first turbine reaches or exceeds the normal operating capacity of the first turbine, another portion of the steam generated using solar energy is mixed with steam driving the third turbine, with feedwater from which is generated steam driving the third turbine, or with both.

In any of the above variations of this method, steam may be generated directly from water using solar energy, for example, by concentrating solar radiation onto a vessel or conduit containing the water. Alternatively, or in addition, concentrated solar radiation may be used to heat a heat transfer fluid, and then heat from the heat transfer fluid may be transferred to water to generate the steam.

Consequently, in one instance, a power plant may comprise a solar steam and/or hot water generator configured to heat the steam and/or water using solar energy; a first turbine in fluid communication with and driven by a fluid heated by a main energy source other than solar energy (e.g. natural gas or coal); a fluid coupling (e.g. conduit such as piping) connecting the solar steam and/or hot water generator with said first turbine to transfer hot water and/or steam generated using solar energy as an auxiliary energy input source for the first turbine. Optionally, the first turbine is a steam turbine. In either instance, the power plant may additionally comprise (1) a solar steam turbine in fluid communication with the solar steam generator (through e.g. conduit such as pipe or duct) to receive steam therefrom; (2) a second steam generator which uses the main energy source other than solar energy, the first turbine being driven by steam generated by the second steam generator using an energy source other than solar energy (e.g. natural gas or coal); (3) a feedwater preheater coupled to and in fluid communication (via e.g. separate conduit such as pipe) with (a) the solar steam generator to receive steam from the solar steam generator, and (b) the second steam generator to provide the second steam generator with feedwater heated by the steam received from the solar steam generator; and (4) a flow controller that increases the flow of steam from the solar steam generator to the feedwater preheater when the steam driving the solar steam turbine reaches or exceeds the normal operating capacity of the solar steam turbine. Optionally, a power plant may also include (1) a second feedwater preheater coupled to and in fluid communication (via e.g. conduit such as pipe) with (a) the solar steam turbine to receive steam extracted from the solar steam turbine and (b) the solar steam generator to provide the solar steam generator with feedwater heated by the extracted steam; and (2) a steam extraction flow controller that decreases the flow of extracted steam from the solar steam turbine to the second feedwater preheater when the steam driving the solar steam turbine reaches or exceeds the normal operating capacity of the solar steam turbine.

Any of the power plants discussed above and herein may further comprise (1) a combustion turbine; (2) a heat recovery steam generator that generates steam using hot exhaust from the combustion turbine and is coupled to and in fluid communication with (via e.g. conduit such as pipe or duct) the solar steam generator to receive steam from the solar steam generator and mix said steam with (a) steam generated using the hot exhaust, with (b) feedwater from which steam is generated using the hot exhaust, or with both; where the first steam turbine is driven by the heat recovery steam generator.

In any instance described above or herein, a power plant may be configured so that the first turbine is a combustion turbine. A power plant may further comprise a fuel preheater coupled to and in fluid communication with (via e.g. conduit such as pipe) (a) the solar steam and/or hot water generator to receive hot water and/or steam, and (b) the combustion turbine to provide fuel preheated with the hot water and/or steam. Any of these power plants may further have a solar steam turbine driven by steam generated by the solar steam and/or hot water generator. Other variations as described below and in the appended claims may be utilized.

Consequently, in another aspect, a power plant comprises a solar steam generator, a turbine driven by steam generated by the solar steam generator, and a feedwater preheater fluidly coupled to the turbine to receive steam extracted from the turbine and fluidly coupled to the solar steam generator to provide the solar steam generator with feedwater heated by the extracted steam. The power plant further comprises a steam extraction flow controller that decreases the flow of extracted steam from the turbine to the feedwater preheater when the steam driving the turbine reaches or exceeds the normal operating capacity of the turbine.

In another aspect, a power plant comprises a solar steam generator, a first turbine driven by steam generated by the solar steam generator, a second steam generator, a second turbine driven by steam generated by the second steam generator using an energy source other than solar energy, and a feedwater preheater fluidly coupled to the solar steam generator to receive steam from the solar steam generator and fluidly coupled to the second steam generator to provide the second steam generator with feedwater heated by the steam received from the solar steam generator. The power plant further comprises a flow controller that increases the flow of steam from the solar steam generator to the feedwater preheater when the steam driving the first turbine reaches or exceeds the normal operating capacity of the first turbine.

Some variations of this power plant comprise a second feedwater preheater fluidly coupled to the first turbine to receive steam extracted from the first turbine and fluidly coupled to the solar steam generator to provide the solar steam generator with feedwater heated by the extracted steam, and a steam extraction flow controller that decreases the flow of extracted steam from the first turbine to the second feedwater preheater when the steam driving the first turbine reaches or exceeds the normal operating capacity of the first turbine.

In another aspect, a power plant comprises a solar steam generator, a first turbine driven by steam generated by the solar steam generator, a combustion turbine, a heat recovery steam generator that generates steam using hot exhaust from the combustion turbine and is fluidly coupled to the solar steam generator to receive steam from the solar steam generator and mix it with steam generated using the hot exhaust, with feedwater from which steam is generated using the hot exhaust, or with both, and a third turbine driven by steam generated by the heat recovery steam generator. The power plant further comprises a flow controller that, when the steam driving the first turbine reaches or exceeds the normal operating capacity of the first turbine, increases the flow of steam from the solar steam generator to the heat recovery steam generator.

Some variations of this power plant comprise a feedwater preheater fluidly coupled to the first turbine to receive steam extracted from the first turbine and fluidly coupled to the solar steam generator to provide the solar steam generator with feedwater heated by the extracted steam, and a steam extraction flow controller that decreases the flow of extracted steam from the first turbine to the feedwater preheater when the steam driving the first turbine reaches or exceeds the normal operating capacity of the first turbine.

In another aspect, a power plant comprises a solar hot water and steam generator that generates hot water, steam, or hot water and steam, and a combustion turbine. The power plant further comprises a fuel preheater fluidly coupled to the solar hot water and steam generator to receive hot water, steam, or hot water and steam, and fluidly coupled to the combustion turbine to provide it with fuel preheated with the hot water, steam, or hot water and steam.

Some variations of this power plant comprise a second turbine driven by steam generated by the solar hot water and steam generator. Some variations comprising the second turbine further comprise a flow controller that, when the steam is insufficient to drive the second turbine, increases the flow of hot water, steam, or hot water and steam to the fuel preheater.

Some combinations of this power plant comprise (in combination with any of the above variations comprising a second turbine) a flow controller that, when the steam driving the second turbine reaches or exceeds the normal operating capacity of the second turbine, increases the flow of hot water, steam, or hot water and steam to the fuel preheater.

Some combinations of this power plant comprise (in combination with any of the above variations comprising a Second turbine) a feedwater preheater fluidly coupled to the second turbine to receive steam extracted from the second turbine and fluidly coupled to the solar hot water and steam generator to provide it with feedwater heated by the extracted steam, and a steam extraction flow controller that decreases the flow of extracted steam from the second turbine to the feedwater preheater when the steam driving the second turbine reaches or exceeds the normal operating capacity of the second turbine.

Some combinations of this power plant comprise (in combination with any of the above variations comprising a second turbine) a heat recovery steam generator that generates steam using hot exhaust from the combustion turbine and is fluidly coupled to the solar hot water and steam generator to receive steam from the solar hot water and steam generator and mix it with steam generated using the hot exhaust, with feedwater from which steam is generated using the hot exhaust, or with both, a third turbine driven by steam generated by the heat recovery steam generator, and a flow controller that, when the steam driving the second turbine reaches or exceeds the normal operating capacity of the second turbine, increases the flow of steam from the solar hot water and steam generator to the heat recovery steam generator.

In the power plants summarized above and further described below in this specification, solar steam generators and solar hot water and steam generators may comprise any suitable apparatus or system, known to one of ordinary skill in the art or later developed, for generating steam and/or hot water using solar energy. The methods summarized above and further described below in this specification may generate hot water and/or steam using any such suitable apparatus or systems. Suitable solar steam and/or hot water generators may comprise, for example, linear Fresnel reflector solar energy collection systems, trough reflector solar energy collection systems, central receiver solar energy collection systems, and/or dish reflector solar energy collection systems.

The normal operating capacity of a turbine, as referred to in this summary and further below in this specification, may be given by the nameplate rating of the turbine provided by turbine manufacturer, or derived from the nameplate rating (e.g., by using a turbine efficiency factor to convert from an electric power nameplate rating to thermal power).

The solar steam generators utilized in the methods, apparatus, and systems described herein may be sized so that their peak thermal power output (e.g., at peak solar irradiance on a particular day of the year) is, in some variations, equal to or greater than a factor of, for example, about 1.5, about 2.0, about 2.5, or about 3.0 times the normal operating capacity of a turbine driven by that output. This may allow the solar steam generators to drive such turbines at or close to their normal operating capacity when the solar irradiance is less (e.g., significantly less) than its peak, and may provide excess hot water or steam capacity that may be utilized in some variations of the methods and systems described herein.

Hot water, steam, or hot water and steam may also be available from a solar steam generator to be utilized in some variations of the methods and systems described herein when, for example, the solar irradiance is too low for the output of the solar steam generator to drive a turbine. Hot water, steam, or hot water and steam may similarly be available when, for example, the steam generator is starting-up or shutting down and its output is consequentially insufficient to drive a turbine.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 shows an example solar power plant.

FIGS. 2A-2C illustrate example uses of steam to increase the net power output of a solar power plant: driving a feedwater pump (FIG. 2A), driving a mechanical vapor compression chiller that cools a generator (FIG. 2B), and driving an absorption chiller that cools a generator (FIG. 2C).

FIG. 3 shows an example power plant comprising a solar power plant section and a conventional (i.e., non-solar) power plant section.

FIG. 4 shows an example power plant comprising a solar power plant section and a conventional (i.e., non-solar) combined cycle power plant section.

FIG. 5 shows an example power plant comprising a combustion turbine and a solar steam generator that generates steam or hot water used to preheat a fuel combusted in the combustion turbine.

FIG. 6 shows another example power plant comprising a solar power plant section and a conventional (i.e., non-solar) combined cycle power plant section.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used in this specification and the appended claims, the singular forms “a,” “an,” and “the” include plural referents unless the context clearly indicates otherwise.

Disclosed herein are methods, systems, and apparatus by which steam and/or hot water generated using solar energy may be utilized. Some variations of these methods, systems, and apparatus may be advantageous in situations (e.g., times of day or year) in which the steam is generated in excess of the normal operating capacity of a turbine driven by the steam. Some of these methods, systems, and apparatus may alternatively, or additionally, be advantageous in situations (e.g., times of day or year or at start-up or shut-down of a solar steam generator) in which the steam generated is insufficient to drive a turbine.

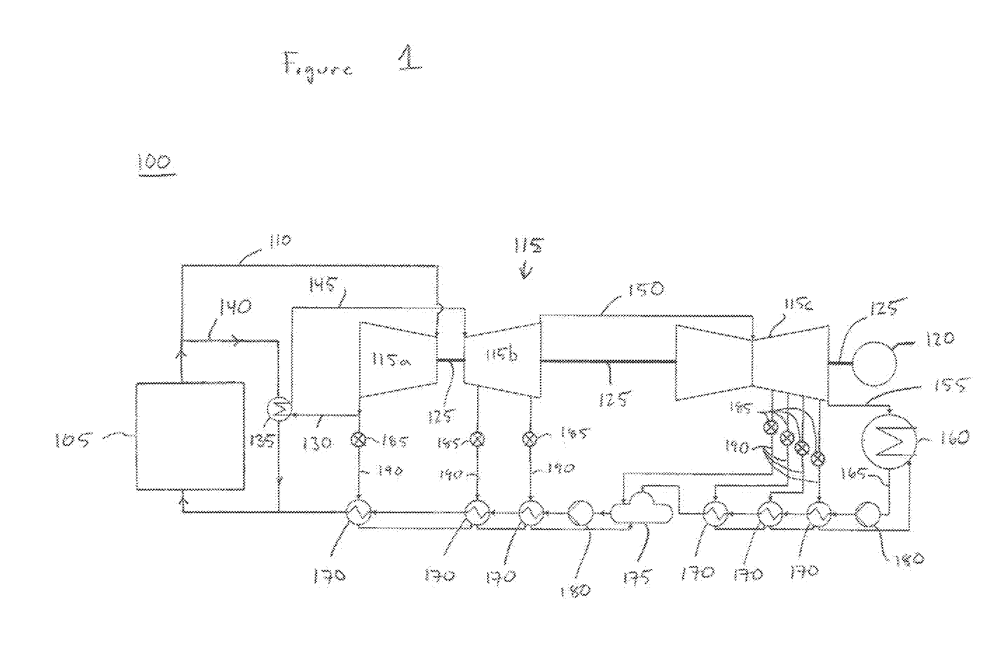

Referring now to FIG. 1, an example solar power plant 100 comprises a solar steam generator 105 providing steam 110 generated using solar energy to a solar steam turbine 115. In the illustrated example, solar steam turbine 115 comprises high pressure (115a), intermediate pressure (115b), and low pressure (115c) sections.

Steam 110 expands across and drives (rotates) high pressure solar steam turbine section 115a, which in turn drives electric generator 120 via drive shaft (or other suitable mechanical coupling) 125 to produce electricity. Expanded steam 130 exhausted from high pressure solar steam turbine section 115a is reheated in reheater heat exchanger 135 by heat transfer from steam 140, which is also provided by solar steam generator 105. Reheated steam 145 then expands across and drives intermediate pressure solar steam turbine section 115b. Expanded steam 150 exhausted from intermediate pressure solar steam turbine section 115b is then further expanded across low pressure solar steam turbine section 115c. Intermediate pressure solar steam turbine section 115b and low pressure solar steam turbine section 115c also drive generator 120 via shaft 125 or other suitable mechanical couplings.

Exhaust steam 155 exiting solar steam turbine 115 (as illustrated, through low pressure solar steam turbine section 115c) is condensed in condenser 160. Feedwater stream 165 exiting condenser 160 is preheated and deaerated by one or more steam extracting feedwater heaters 170 and one or more deaerators 175, and returned to solar steam generator 105 where it may be again converted to steam using solar energy. Such circulation of feedwater stream 165 may be induced, for example, using one or more feedwater pumps 180.

Steam extraction flow controllers 185 control the flow of steam 190 extracted from solar steam turbine 115 to preheat and/or deaerate feedwater stream 165 in feedwater heaters 170 and deaerator 175. Flow controllers 185 may comprise, for example, any suitable valve (e.g., solenoid valve) or combination of valves that may be used to control the flow of extracted steam from solar steam turbine 115 to feedwater heaters 170 and deaerator 175. (Similarly, all other steam, water, or other fluid flow controllers referred to herein may comprise, for example, any suitable valve or combination of valves).

Generation of steam 110 by solar steam generator 105 may vary during a day, or during a year, as solar irradiance varies, as well as during start-up and shut-down. When the flow of steam 110 provided by solar steam generator 105 to solar steam turbine 115 reaches or exceeds the normal operating capacity of solar steam turbine 115, one or more of flow controllers 185 reduces or entirely stops the flow 190 of extracted steam it or they control. In one variation, only the flow of steam extracted from the high pressure section 115a of the solar steam turbine is reduced or stopped entirely. In other variations, the flow of steam extracted from the intermediate pressure solar steam turbine section 115b and/or the low pressure solar steam turbine section 115c is additionally, or alternatively, reduced or stopped entirely.

As noted above in the summary section, heating of feedwater stream 165 that would have occurred in the feedwater preheaters and/or deaerator may instead occur in solar steam generator 105. The reduced extraction of steam from solar steam turbine 115 for feedwater preheating and/or deaerating may increase the mass flow through solar steam turbine 115 and hence increase its power output.

Although in the illustrated example solar steam turbine 115 comprises high pressure, intermediate pressure, and low pressure sections, this is not required. In some variations solar steam turbine 115 comprises only one section, two sections, three sections (e.g., as illustrated), or more than three sections.

Steam 110 provided by solar steam generator 105 may be, for example, saturated steam having temperatures of about 240° C. to about 305° C. and pressures of about 35 bar to about 90 bar, or superheated steam having temperatures of about 370° C. to about 555° C. and pressures of about 100 bar to about 165 bar. Solar steam turbine 115 may have a nameplate capacity of, for example, about 5 to about 400 MW (electric). Solar steam generator 105 may have a yearly peak thermal power output (e.g., as estimated from solar irradiance and sun position data at the location of the solar steam generator), for example, of about 1.5, about 2.0, about 2.5, or about 3.0 times the thermal power equivalent of the nameplate rating of solar steam turbine 115.

In some variations, when the flow of steam 110 provided by solar steam generator 105 to solar steam turbine 115 reaches or exceeds the normal operating capacity of solar steam turbine 115, some of the steam produced by solar steam generator 105 may be used elsewhere in power plant 100 to increase the net power output (i.e., power produced less power consumed) of the power plant. Such use of steam may be in addition to, or an alternative to, reducing or entirely stopping steam extraction as described above. The flow of steam from solar steam generator 105 to such other uses may be controlled, for example, using steam flow controllers (e.g., valves) similar or identical to flow controllers 185 described above.

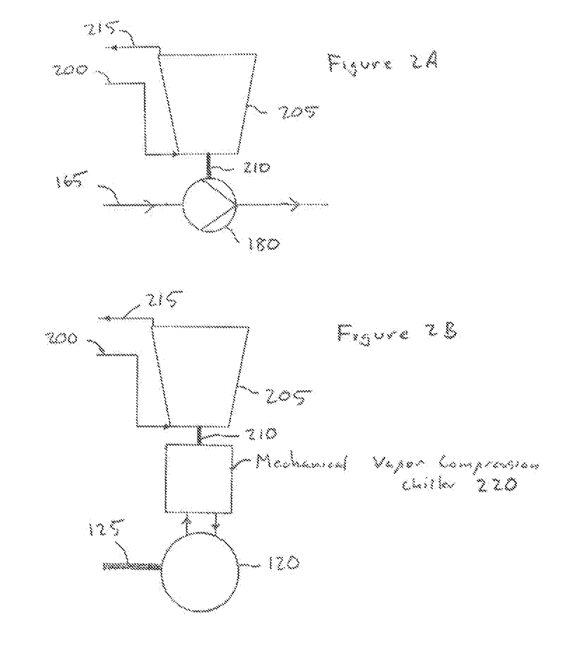

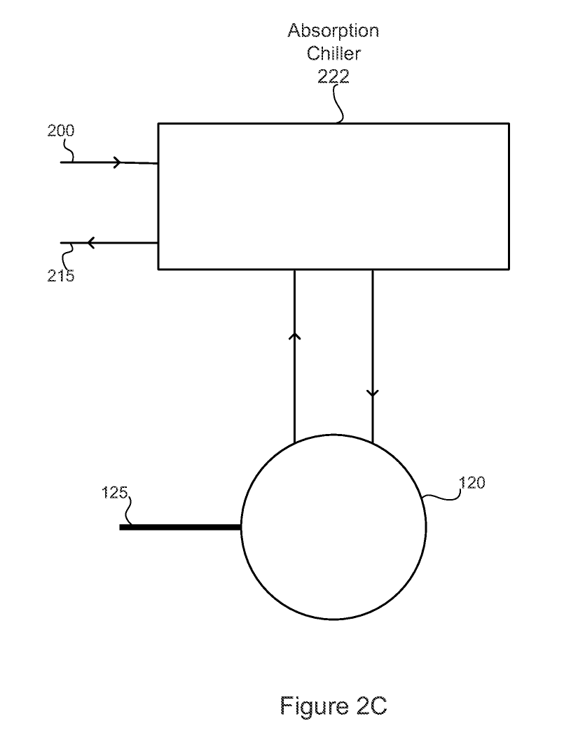

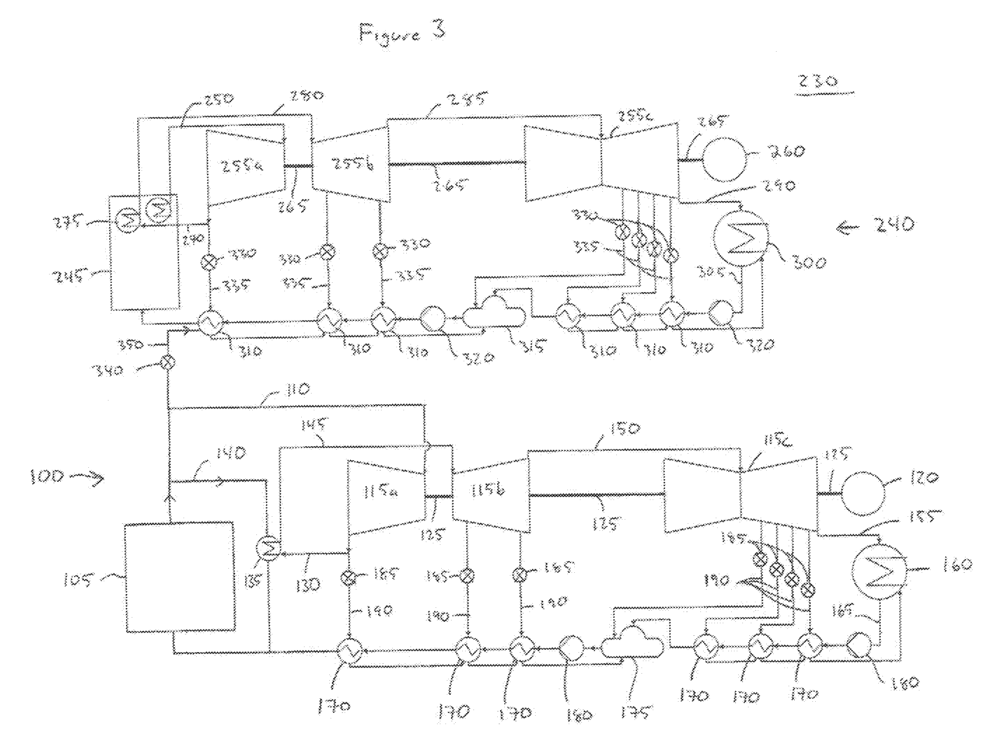

Referring to FIG. 2A, in one variation steam 200 from solar steam generator 105 drives a small steam turbine or piston engine 205, which then drives a feedwater (or other) pump 180 via a drive shaft 210 or other suitable mechanical coupling. Feedwater pump 180 pumps feedwater stream 165 through the power plant. Exhaust steam 215 may be directed, for example, to condenser 160 (FIG. 1). In another variation (FIG. 2B), steam 200 from solar steam generator 105 drives a small steam turbine or piston engine 205, which then drives a mechanical vapor compression chiller 220 via a drive shaft 210 or other suitable mechanical coupling. Mechanical vapor compression chiller 220 cools electric generator 120. In yet another variation, steam 200 from solar steam generator 105 powers an (e.g., conventional) absorption chiller 222 that cools electric generator 120. Using solar steam power rather than electric power, for example, to drive such pumps or chillers may increase the overall electric power output of the power plant.

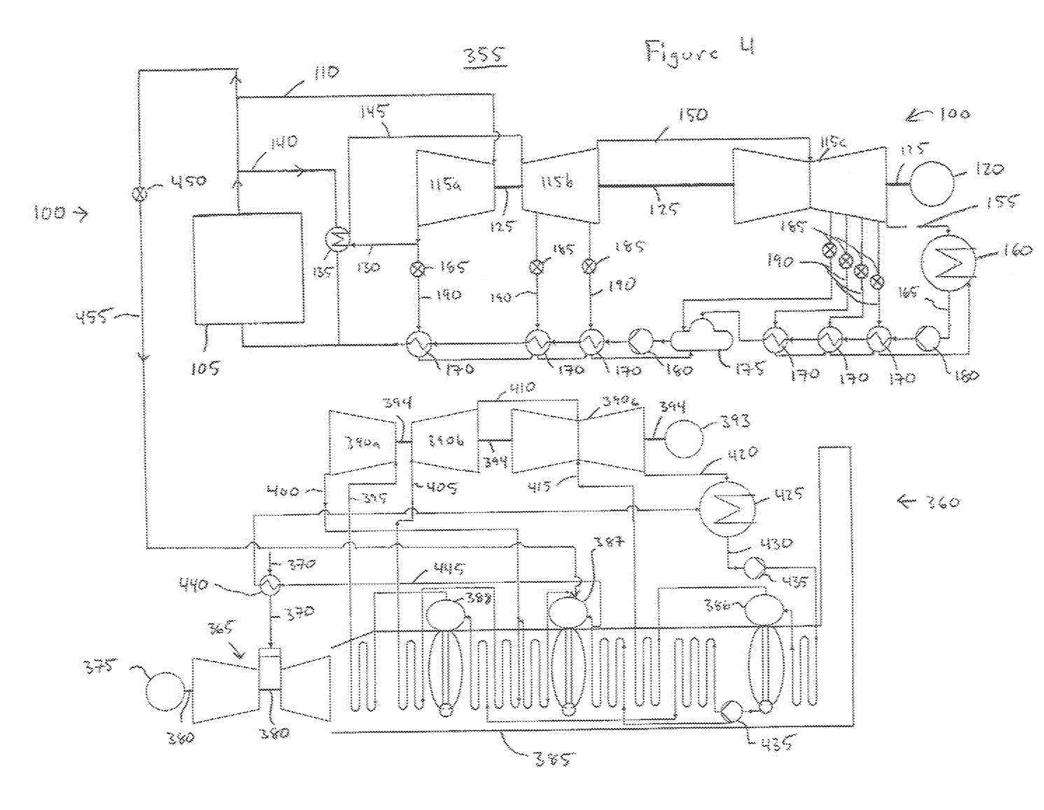

Referring now to FIG. 3, a power plant 230 comprises (1) a conventional (i.e., non-solar) power plant section 240 having a turbine driven by a fluid such as steam having energy obtained from a main energy source other than solar energy, and (2) a solar power plant section 100 that may provide a hot fluid such as steam generated with solar energy as an auxiliary energy input to the turbine. Solar power plant section 100 can be configured and operated, for example, according to any of the variations described above.

Power plant section 240 comprises a boiler 245 providing steam 250 to a steam turbine 255. Boiler 245 utilizes an energy source other than solar energy to generate the steam. For example, boiler 245 may combust a fossil fuel (e.g., coal, oil, or natural gas), combust biomass, or utilize nuclear or geothermal power to generate steam 250. In the illustrated example, steam turbine 255 comprises high pressure (255a), intermediate pressure (255b), and low pressure (255c) sections.

Steam 250 expands across and drives (rotates) high pressure turbine section 255a, which in turn drives electric generator 260 via drive shaft (or other suitable mechanical coupling) 265 to produce electricity. Expanded steam 270 exhausted from high pressure turbine section 255a is reheated in reheater 275 in boiler 245 to provide reheated steam 280. Reheated steam 280 expands across and drives intermediate pressure turbine section 255b. Expanded steam 285 exhausted from intermediate pressure turbine section 255b is then further expanded across low pressure turbine section 255c. Intermediate pressure turbine section 255b and low pressure turbine section 255c also drive generator 260 via shaft 265 or other suitable mechanical couplings.

Exhaust steam 290 exiting turbine 255 (as illustrated, through low pressure turbine section 255c) is condensed in condenser 300. Feedwater stream 305 exiting condenser 300 is preheated and deaerated by one or more steam extracting feedwater heaters 310 and one or more deaerators 315, and returned to boiler 245 where it may be again converted to steam. Such circulation of feedwater stream 305 may be induced, for example, using one or more feedwater pumps 320.

Steam extraction flow controllers 330 control the flow of steam 335 extracted from turbine 255 to preheat and/or deaerate feedwater stream 305 in feedwater heaters 310 and deaerator 315.

Although in the illustrated example turbine 255 comprises high pressure, intermediate pressure, and low pressure sections, this is not required. In some variations turbine 255 comprises only one section, two sections, three sections (e.g., as illustrated), or more than three sections.

Referring again to the solar power plant section 100 of power plant 230, when the flow of steam 110 provided by solar steam generator 105 to solar steam turbine 115 reaches or exceeds the normal operating capacity of solar steam turbine 115, steam flow controller 340 begins (or increases) a flow of steam 350 from solar steam generator 105 into feedwater heaters 310 of conventional power plant section 240. In addition, in some variations one or more of flow controllers 330 reduce or entirely stop the flow 335 of extracted steam from turbine 255. In some variations, only the flow of extracted steam from the high pressure section 255a of the turbine is reduced or stopped entirely. In other variations, the flow of extracted steam from the intermediate pressure section 255b and/or the low pressure section 255c is additionally, or alternatively, reduced or stopped entirely. Such use of steam from solar steam generator 105 may allow conventional power plant section 240 to produce more electric power for the same output of steam from boiler 245, or the same amount of electric power for a reduced steam output from (and fuel consumption in) boiler 245.

In another variation, when the flow of steam 110 provided by solar steam generator 105 to solar steam turbine 115 is insufficient to drive solar steam turbine 115, steam flow controller 340 begins (or increases) a flow of steam 350 from solar steam generator 105 into feedwater heaters 310 of conventional power plant section 240. Flow controllers 330 may reduce or entirely stop the flow 335 of extracted steam from turbine 255 as described in the above variations.

In another variation, when the flow of steam 110 provided by solar steam generator 105 to solar steam turbine 115 reaches or exceeds the normal operating capacity of solar steam turbine 115, additional steam generated in solar steam generator 105 is provided directly to turbine 255. For example, steam generated in solar steam generator 105 may be mixed with steam 250 driving high pressure turbine section 255a, steam 280 driving intermediate pressure turbine section 255b, and/or steam 285 driving low pressure turbine section 255c. Such flow of steam from solar steam generator 105 to turbine 255 may be regulated with one or more flow controllers (not shown in the figure) used in a manner similar to flow controller 340. Such use of steam from solar steam generator 105 to drive turbine 255 may be in addition to or an alternative to utilizing steam generated by solar steam generator 105 to heat feedwater in conventional power plant section 240.

In some variations, when the flow of steam 110 provided by solar steam generator 105 to solar steam turbine 115 reaches or exceeds the normal operating capacity of solar steam turbine 115, additional steam generated in solar steam generator 105 may be used elsewhere in conventional power plant section 240 to increase the net output power of that section. For example, steam from steam generator 105 may be used to power one or more feedwater pumps in section 240 and/or to power a chiller that cools generator 260.

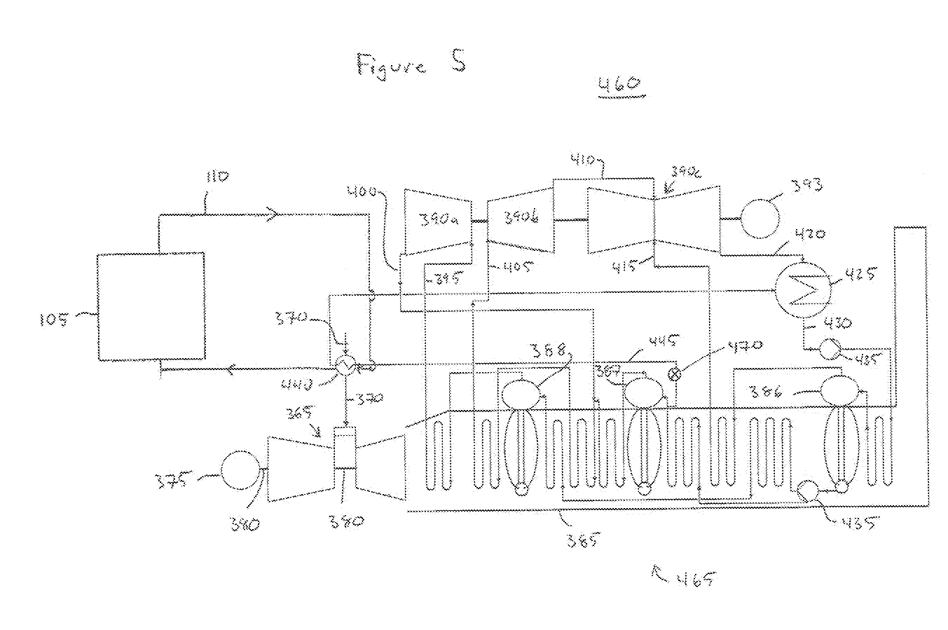

Referring now to FIG. 4, a power plant 355 comprises (1) a conventional (i.e., non-solar) combined cycle power plant section 360 having a turbine driven by a fluid such as hot exhaust gas and/or steam having energy obtained from a main energy source other than solar energy, and (2) a solar power plant section 100 that may provide a hot fluid such as steam generated with solar energy as an auxiliary energy input to the turbine. Solar power plant section 100 can be configured and operated, for example, according to any of the variations described above.

Conventional power plant section 360 comprises a combustion turbine 365 driven by combustion gas formed by combusting a main energy source, a fuel 370 such as natural gas or oil, in air. Combustion turbine 365 drives an electric generator 375 via a drive shaft 380 or similar suitable mechanical coupling. Hot exhaust from combustion turbine 365 is directed into a heat recovery steam generator (HRSG) 385 to heat feedwater to generate steam in a feedwater/steam circuit comprising, in the illustrated example, a low pressure evaporator 386, a medium pressure evaporator 387, and a high pressure evaporator 388. Steam generated in HRSG 385 drives a steam turbine 390.

In the illustrated example, steam turbine 390 comprises high pressure (390a), intermediate pressure (390b), and low pressure (390c) sections. Superheated steam 395 generated in HRSG 385 expands across and drives high pressure turbine section 390b, which in turn drives electric generator 393 via drive shaft 394 or other suitable mechanical coupling. Expanded steam 400 exhausted from high pressure turbine section 390b returns to HRSG 385, to be combined with steam from intermediate pressure evaporator 387 and further heated to provide steam 405. Steam 405 expands across and drives intermediate pressure turbine section 390b. Expanded steam 410 exhausted from intermediate pressure turbine section 390b is further expanded across and drives low pressure turbine section 390c. Additional steam 415 generated in HRSG 385 also expands across and drives low pressure turbine section 390c. Intermediate pressure turbine section 390b and low pressure turbine section 390c also drive generator 393 via shaft 394 or other suitable mechanical couplings.

Exhaust steam 420 exiting turbine 390 (as illustrated, through low pressure turbine section 390c) is condensed in condenser 425. Feedwater stream 430 exiting condenser 425 is then directed into feedwater/steam circuit in HRSG 385. Circulation of feedwater through HRSG 385 may be induced, for example, with pumps 435.

Fuel 370 for combustion turbine 365 may be preheated, as in the illustrated example, by heat transfer in heat exchanger 440 from steam 445 generated in HRSG 385.

Although in the illustrated example turbine 390 comprises high pressure, intermediate pressure, and low pressure sections, this is not required. In some variations turbine 390 comprises only one section, two sections, three sections (e.g., as illustrated), or more than three sections. In such variations the configuration and operation of HRSG 385 may be suitably modified to provide steam as necessary to drive the turbine sections present.

Referring again to the solar power plant section 100 of power plant 355, when the flow of steam 110 provided by solar steam generator 105 to solar steam turbine 115 reaches or exceeds the normal operating capacity of solar steam turbine 115, steam flow controller 450 begins (or increases) a flow of steam 455 from solar steam generator 105 into the feedwater/steam circuit in HRSG 385 to provide an auxiliary energy input to drive turbine 390. Such use of steam from solar steam generator 105 in the steam circuits driving turbine 390 may allow power plant section 360 to produce more electric power for the same rate of fuel consumption, or the same amount of power for a reduced amount of fuel consumption.

In the illustrated example, steam from solar steam generator 105 is introduced into HRSG 385 at intermediate pressure evaporator 387 as an auxiliary energy input to drive turbine 390. In some variations, the solar generated steam is introduced into HRSG 385 additionally, or alternatively, at high pressure evaporator 388 and/or low pressure evaporator 386. Steam from solar steam generator 385 may also, or alternatively, be introduced into HRSG 385 at any other suitable location or locations.

In another variation, when the flow of steam 110 provided by solar steam generator 105 to solar steam turbine 115 is insufficient to drive solar steam turbine 115, steam flow controller 450 begins (or increases) a flow of steam 455 from solar steam generator 105 into the feedwater/steam circuit in HRSG 385 to provide an auxiliary energy input to drive turbine 390. The solar generated steam may be introduced into HRSG 385 as described in any of the above variations, and may provide similar benefits.

In some variations, when the flow of steam 110 provided by solar steam generator 105 to solar steam turbine 115 reaches or exceeds the normal operating capacity of solar steam turbine 115, additional steam generated in solar steam generator 105 may be used elsewhere in conventional combined cycle power plant section 360 as an auxiliary energy input to drive turbine 390 to increase the net output power of that section. For example, steam from steam generator 105 may be used to power one or more feedwater pumps in section 360 and/or to power one or more chillers that cool generator 375, generator 393, or both.

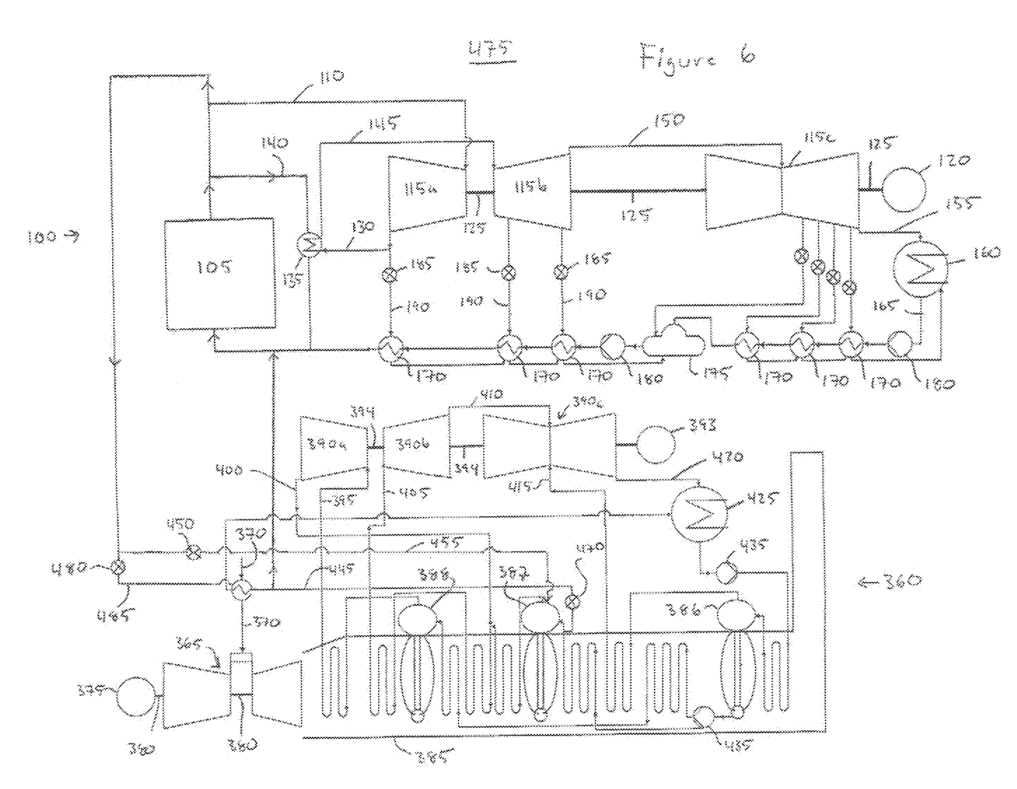

Referring now to FIG. 5, a power plant 460 comprises a conventional (i.e., non-solar) combined cycle power plant configured and operated similarly to power plant section 360 shown in FIG. 4. Power plant 460 also comprises a solar steam generator 105. Solar steam generator 105 provides hot water, steam, or hot water and steam to heat exchanger 440 to preheat a main energy source such as a fuel 370 for combustion turbine 365. When solar steam generator is providing such hot water and/or steam as an auxiliary energy input to preheat the fuel, a steam flow controller 470 may reduce or entirely stop extracting steam 445 from HRSG 385 that would otherwise be used to preheat the fuel.

Although in the illustrated example combustion turbine 365 is part of a conventional (i.e., non-solar) combined cycle power plant, in other variations, steam turbine 390 and HRSG 385 may be absent or may be present in modified form. In some variations, solar steam generator 105 is the only, or the primary, source of energy for preheating fuel 370 to combustion turbine 365.

Referring now to FIG. 6, a power plant 475 comprises a solar power plant section 100 and a conventional (i.e., non-solar) combined cycle power plant section 360 using a main energy source other than solar energy to heat a working fluid and drive a turbine to generate electric power. Solar power plant section 100 can be configured and operated, for example, according to any of the variations described above. Conventional combined cycle power plant section 360 can be configured and operated, for example, according to any of the variations described above.

When the flow of steam 110 provided by solar steam generator 105 to solar steam turbine 115 reaches or exceeds the normal operating capacity of solar steam turbine 115, steam flow controller 450 begins (or increases) a flow of steam 455 from solar steam generator 105 into the feedwater/steam circuit in HRSG 385 as an auxiliary energy input. Such use of steam from steam generator 105 in HRSG 385 may be, for example, according to any of the variations described above with respect to power plant 355 (FIG. 4), and may provide similar benefits.

Alternatively, or additionally, when the flow of steam 110 provided by solar steam generator 105 to solar steam turbine 115 is insufficient to drive solar steam turbine 115, steam flow controller 450 begins (or increases) a flow of steam 455 from solar steam generator 105 into the feedwater/steam circuit in HRSG 385 as an auxiliary energy input. The solar generated steam may be introduced into HRSG 385 as described in any of the above variations, and may provide similar benefits.

Alternatively, or in addition to any of the above variations of power plant 475, when the flow of steam 110 provided by solar steam generator 105 to solar steam turbine 115 reaches or exceeds the normal operating capacity of solar steam turbine 115, steam flow controller 480 begins (or increases) a flow 485 of hot water, steam, or hot water and steam from solar steam generator 105 to heat exchanger 440 as an auxiliary energy input to preheat fuel 370 for combustion turbine 365. Steam flow controller 470 may optionally reduce or entirely stop extraction of steam 445 from HRSG 385 that would otherwise be used to preheat the fuel.

Alternatively, or in addition to any of the above variations of power plant 475, when the flow of steam 110 provided by solar steam generator 105 to solar steam turbine 115 is insufficient to drive solar steam turbine 115, steam flow controller 480 begins (or increases) a flow 485 of hot water, steam, or hot water and steam from solar steam generator 105 to heat exchanger 440 as an auxiliary energy input to preheat fuel for combustion turbine 365. Steam flow controller 470 may optionally reduce or entirely stop extraction of steam 445 from HRSG 385 that would otherwise be used to preheat the fuel.

As noted in the summary, solar steam generators as referred to herein may comprise, for example, linear Fresnel reflector solar energy collection systems. Suitable linear Fresnel systems may include, but are not limited to, those disclosed in U.S. patent application Ser. No. 10/597,966 titled “Multi-Tube Solar collector Structure,” filed Aug. 14, 2006, U.S. patent application Ser. No. 12/012,821 titled “Linear Fresnel Solar Arrays and Drives Therefor,” filed Feb. 5, 2008, U.S. patent application Ser. No. 12/012,829 titled “Linear Fresnel Solar Arrays and Receivers Therefor,” filed Feb. 5, 2008, and U.S. patent application Ser. No. 12/012,920 titled “Linear Fresnel Solar Arrays and Components Therefor,” filed Feb. 5, 2008, all of which are incorporated by reference herein in their entirety.

Also as noted in the summary, solar steam generators may generate steam from water directly with concentrated solar radiation. Alternatively, solar steam generators may heat a heat transfer fluid (such as an oil or a molten salt, for example) with concentrated solar radiation, and then transfer heat from the heat transfer fluid to water in a heat exchanger to heat the water to product hot water and/or steam.

Based on the preceding discussion, the following is a list of some methods and apparatus disclosed herein:

1. A method of operating a solar power plant, the method comprising:

generating steam from feedwater using solar energy;

driving a turbine with at least a portion of the steam;

extracting from the turbine a portion of the steam driving the turbine;

preheating the feedwater with the extracted steam; and

when the steam driving the turbine reaches or exceeds the normal operating capacity of the turbine, reducing the amount of steam extracted from the turbine for preheating the feedwater.

2. The method of paragraph 1, comprising heating the feedwater with concentrated solar radiation to generate the steam.
3. The method of paragraph 1, comprising:

heating a heat transfer fluid with solar energy, and

transferring heat from the heat transfer fluid to the feedwater to generate the steam.

4. The method of any of paragraphs 1-3, comprising:

when the steam driving the turbine reaches or exceeds the normal operating capacity of the turbine, pumping the feedwater with a pump powered with another portion of the steam.

5. The method of any of paragraphs 1-4, comprising:

driving an electric generator with the turbine; and

when the steam driving the turbine reaches or exceeds the normal operating capacity of the turbine, cooling the generator with a chiller powered with another portion of the steam.

6. A method of operating a solar power plant, the method comprising:

generating steam from feedwater using solar energy;

driving a turbine with at least a portion of the steam; and

when the steam driving the turbine reaches or exceeds the normal operating capacity of the turbine, pumping the feedwater with a pump powered with another portion of the steam.

7. The method of paragraph 6, comprising heating the feedwater with concentrated solar radiation to generate the steam.
8. The method of paragraph 6, comprising:

heating a heat transfer fluid with solar energy, and

transferring heat from the heat transfer fluid to the feedwater to generate the steam.

9. A method of operating a solar power plant, the method comprising:

generating steam using solar energy;

driving a turbine with at least a portion of the steam;

driving an electric generator with the turbine; and

when the steam driving the turbine reaches or exceeds the normal operating capacity of the turbine, cooling the generator with a chiller powered with another portion of the steam.

10. The method of paragraph 9, wherein the chiller comprises a mechanical vapor compression chiller.
11. The method of Paragraph 9, wherein the chiller comprises an absorption chiller.
12. The method of any of paragraphs 9-11, wherein generating steam using solar energy comprises heating water with concentrated solar radiation.
13. The method of any of paragraphs 9-11, wherein generating steam using solar energy comprises:

heating a heat transfer fluid with solar energy, and

transferring heat from the heat transfer fluid to water.

14. A method of operating a power plant, the method comprising:

generating steam using solar energy;

driving a first turbine with at least a portion of the steam generated using solar energy;

generating steam using an energy source other than solar energy;

driving a second turbine with at least a portion of the steam generated using an energy source other than solar energy, and

when the steam driving the first turbine reaches or exceeds the normal operating capacity of the first turbine, using another portion of the steam generated using solar energy to preheat feedwater from which is generated at least a portion of the steam driving the second turbine.

15. The method of paragraph 14, comprising:

extracting from the first turbine a portion of the steam driving the first turbine;

preheating, with the extracted steam, feedwater from which is generated at least a portion of the steam driving the first turbine; and

when the steam driving the first turbine reaches or exceeds the normal operating capacity of the first turbine, reducing the amount of steam extracted from the first turbine for preheating feedwater.

16. The method of paragraph 14 or paragraph 15, wherein generating steam using solar energy comprises heating water with concentrated solar radiation.
17. The method of paragraph 14 or paragraph 15, wherein generating steam using solar energy comprises:

heating a heat transfer fluid with solar energy, and

transferring heat from the heat transfer fluid to water.

18. A method of operating a power plant, the method comprising:

generating steam using solar energy;

driving a first turbine with at least a portion of the steam generated using solar energy;

generating steam using an energy source other than solar energy;

driving a second turbine with at least a portion of the steam generated using an energy source other than solar energy, and

when the steam driving the first turbine reaches or exceeds the normal operating capacity of the first turbine, mixing another portion of the steam generated using solar energy with the steam driving the second turbine.

19. The method of paragraph 18, comprising:

extracting from the first turbine a portion of the steam driving the first turbine;

preheating, with the extracted steam, feedwater from which is generated at least a portion of the steam driving the first turbine; and

when the steam driving the first turbine reaches or exceeds the normal operating capacity of the first turbine, reducing the amount of steam extracted from the first turbine for preheating feedwater.

20. The method of paragraph 18 or paragraph 19, wherein generating steam using solar energy comprises heating water with concentrated solar radiation.
21. The method of paragraph 18 or paragraph 19, wherein generating steam using solar energy comprises:

heating a heat transfer fluid with solar energy, and

transferring heat from the heat transfer fluid to water.

22. A method of operating a power plant, the method comprising:

generating steam using solar energy;

driving a first turbine with at least a portion of the steam generated using solar energy;

operating a combustion turbine;

generating steam using hot exhaust from the combustion turbine;

driving a third turbine with at least a portion of the steam generated using the hot exhaust from the combustion turbine; and

when the steam driving the first turbine reaches or exceeds the normal operating capacity of the first turbine, mixing another portion of the steam generated using solar energy with steam driving the third turbine, with feedwater from which is generated steam driving the third turbine, or with both.

23. The method of paragraph 22, comprising:

extracting from the first turbine a portion of the steam driving the first turbine;

preheating, with the extracted steam, feedwater from which is generated at least a portion of the steam driving the first turbine; and

when the steam driving the first turbine reaches or exceeds the normal operating capacity of the first turbine, reducing the amount of steam extracted from the first turbine for preheating feedwater.

24. The method of paragraph 22 or paragraph 23, wherein generating steam using solar energy comprises heating water with concentrated solar radiation.
25. The method of paragraph 22 or paragraph 23, wherein generating steam using solar energy comprises:

heating a heat transfer fluid with solar energy, and

transferring heat from the heat transfer fluid to water.

26. A method of operating a power plant, the method comprising:

generating hot water, steam, or hot water and steam using solar energy;

preheating a fuel using at least a portion of the hot water, steam, or hot water and steam; and

combusting the fuel in a combustion turbine.

27. The method of paragraph 26, comprising driving a second turbine with another portion of the steam.
28. The method of paragraph 27, comprising:

extracting from the second turbine a portion of the steam driving the second turbine;

preheating, with the extracted steam, feedwater from which is generated at least a portion of the steam driving the second turbine; and

when the steam driving the second turbine reaches or exceeds the normal operating capacity of the second turbine, reducing the amount of steam extracted from the second turbine for preheating the feedwater.

29. The method of paragraph 27 or 28, comprising

generating steam using hot exhaust from the combustion turbine;

driving a third turbine with at least a portion of the steam generated using the hot exhaust from the combustion turbine; and

when the steam driving the second turbine reaches or exceeds the normal operating capacity of the second turbine, mixing another portion of the steam generated using solar energy with steam driving the third turbine, with feedwater from which is generated steam driving the third turbine, or with both.

30. The method of any of paragraphs 26-29, wherein generating hot water, steam, or hot water and steam using solar energy comprises heating water with concentrated solar radiation.
31. The method of any of paragraphs 26-29, wherein generating hot water, steam, or hot water and steam using solar energy comprises:

heating a heat transfer fluid with solar energy, and

transferring heat from the heat transfer fluid to water.

32. A method of operating a power plant, the method comprising:

generating hot water, steam, or hot water and steam using solar energy;

driving a first turbine with at least a portion of the steam;

combusting a fuel in a combustion turbine; and

when the steam is insufficient to drive the first turbine, using at least a portion of the hot water, steam, or hot water and steam to preheat at least a portion of the fuel prior to combusting the fuel in the combustion turbine.

33. The method of paragraph 32, comprising:

when the steam driving the first turbine reaches or exceeds the normal operating capacity of the first turbine, using at least a portion of the hot water, another portion of the steam, or both to preheat the fuel prior to combusting the fuel in the combustion turbine.

34. The method of paragraph 32 or paragraph 33, comprising:

extracting from the first turbine a portion of the steam driving the first turbine;

preheating, with the extracted steam, feedwater from which is generated at least a portion of the steam driving the first turbine; and

when the steam driving the first turbine reaches or exceeds the normal operating capacity of the first turbine, reducing the amount of steam extracted from the first turbine for preheating feedwater.

35. The method of any of paragraphs 32-34, comprising

generating steam using hot exhaust from the combustion turbine;

driving a third turbine with at least a portion of the steam generated using the hot exhaust from the combustion turbine; and

when the steam driving the first turbine reaches or exceeds the normal operating capacity of the first turbine, mixing another portion of the steam generated using solar energy with steam driving the third turbine, with feedwater from which is generated steam driving the third turbine, or with both.

36. The method of any of paragraphs 32-35, wherein generating hot water, steam, or hot water and steam using solar energy comprises heating water with concentrated solar radiation to generate the hot water, steam, or hot water and steam.
37. The method of any of paragraphs 32-35, wherein generating hot water, steam, or hot water and steam using solar energy comprises:

heating a heat transfer fluid with solar energy, and

transferring heat from the heat transfer fluid to water to generate the hot water, steam, or hot water and steam.

38. A method of operating a power plant, the method comprising:

generating steam or hot water and steam using solar energy;

driving a first turbine with at least a portion of the steam;

operating a combustion turbine; and

when the steam driving the first turbine reaches or exceeds the normal operating capacity of the first turbine, using at least a portion of the hot water, another portion of the steam, or both to preheat a fuel prior to combusting the fuel in the combustion turbine.

39. The method of paragraph 38, comprising:

extracting from the first turbine a portion of the steam driving the first turbine;

preheating, with the extracted steam, feedwater from which is generated at least a portion of the steam driving the first turbine; and

when the steam driving the first turbine reaches or exceeds the normal operating capacity of the first turbine, reducing the amount of steam extracted from the first turbine for preheating feedwater.

40. The method of paragraph 38 or paragraph 39, comprising

generating steam using hot exhaust from the combustion turbine;

driving a third turbine with at least a portion of the steam generated using the hot exhaust from the combustion turbine; and

when the steam driving the first turbine reaches or exceeds the normal operating capacity of the first turbine, mixing another portion of the steam generated using solar energy with steam driving the third turbine, with feedwater from which is generated steam driving the third turbine, or with both.

41. The method of any of paragraphs 38-40, wherein generating steam using solar energy comprises heating water with concentrated solar radiation.
42. The method of any of paragraphs 38-40, wherein generating steam using solar energy comprises:

heating a heat transfer fluid with solar energy, and

transferring heat from the heat transfer fluid to water to generate steam.

43. A power plant comprising:

a solar steam generator;

a turbine driven by steam generated by the solar steam generator;

a feedwater preheater fluidly coupled to the turbine to receive steam extracted from the turbine and fluidly coupled to the solar steam generator to provide the solar steam generator with feedwater heated by the extracted steam; and

a steam extraction flow controller that decreases the flow of extracted steam from the turbine to the feedwater preheater when the steam driving the turbine reaches or exceeds the normal operating capacity of the turbine.

44. A power plant comprising:

a solar steam generator;

a first turbine driven by steam generated by the solar steam generator;

a second steam generator;

a second turbine driven by steam generated by the second steam generator using an energy source other than solar energy;

a feedwater preheater fluidly coupled to the solar steam generator to receive steam from the solar steam generator and fluidly coupled to the second steam generator to provide the second steam generator with feedwater heated by the steam received from the solar steam generator; and

a flow controller that increases the flow of steam from the solar steam generator to the feedwater preheater when the steam driving the first turbine reaches or exceeds the normal operating capacity of the first turbine.

45. The power plant of paragraph 44 comprising:

a second feedwater preheater fluidly coupled to the first turbine to receive steam extracted from the first turbine and fluidly coupled to the solar steam generator to provide the solar steam generator with feedwater heated by the extracted steam; and

a steam extraction flow controller that decreases the flow of extracted steam from the first turbine to the second feedwater preheater when the steam driving the first turbine reaches or exceeds the normal operating capacity of the first turbine.

46. A power plant comprising:

a solar steam generator;

a first turbine driven by steam generated by the solar steam generator;

a combustion turbine;

a heat recovery steam generator that generates steam using hot exhaust from the combustion turbine and is fluidly coupled to the solar steam generator to receive steam from the solar steam generator and mix it with steam generated using the hot exhaust, with feedwater from which steam is generated using the hot exhaust, or with both;

a third turbine driven by steam generated by the heat recovery steam generator; and

a flow controller that, when the steam driving the first turbine reaches or exceeds the normal operating capacity of the first turbine, increases the flow of steam from the solar steam generator to the heat recovery steam generator.

47. The power plant of paragraph 46 comprising:

a feedwater preheater fluidly coupled to the first turbine to receive steam extracted from the first turbine and fluidly coupled to the solar steam generator to provide the solar steam generator with feedwater heated by the extracted steam; and

a steam extraction flow controller that decreases the flow of extracted steam from the first turbine to the feedwater preheater when the steam driving the first turbine reaches or exceeds the normal operating capacity of the first turbine.

48. A power plant comprising:

a solar hot water and steam generator that generates hot water, steam, or hot water and steam;

a combustion turbine; and

a fuel preheater fluidly coupled to the solar hot water and steam generator to receive hot water, steam, or hot water and steam, and fluidly coupled to the combustion turbine to provide it with fuel preheated with the hot water, steam, or hot water and steam.

49. The power plant of paragraph 48 comprising a second turbine driven by steam generated by the solar hot water and steam generator.
50. The power plant of paragraph 49 comprising a flow controller that, when the steam is insufficient to drive the second turbine, increases the flow of hot water, steam, or hot water and steam to the fuel preheater.
51. The power plant of paragraph 49 or paragraph 50 comprising a flow controller that, when the steam driving the second turbine reaches or exceeds the normal operating capacity of the second turbine, increases the flow of hot water, steam, or hot water and steam to the fuel preheater.
52. The power plant of any of paragraphs 49-51 comprising:

a feedwater preheater fluidly coupled to the second turbine to receive steam extracted from the second turbine and fluidly coupled to the solar hot water and steam generator to provide it with feedwater heated by the extracted steam; and

a steam extraction flow controller that decreases the flow of extracted steam from the second turbine to the feedwater preheater when the steam driving the second turbine reaches or exceeds the normal operating capacity of the first turbine.

53. The power plant of any of paragraphs 49-52 comprising:

a heat recovery steam generator that generates steam using hot exhaust from the combustion turbine and is fluidly coupled to the solar hot water and steam generator to receive steam from the solar hot water and steam generator and mix it with steam generated using the hot exhaust, with feedwater from which steam is generated using the hot exhaust, or with both;

a third turbine driven by steam generated by the heat recovery steam generator; and

a flow controller that, when the steam driving the second turbine reaches or exceeds the normal operating capacity of the second turbine, increases the flow of steam from the solar hot water and steam generator to the heat recovery steam generator.

Although the methods, apparatus, and systems disclosed herein have been described above with respect to the generation of steam from water using solar energy, and the use of steam and hot water thus generated, this disclosure is intended to apply more broadly to the generation of a vaporous working fluid (e.g., steam) from a liquid working fluid (e.g., water) using solar energy, the generation of hot working fluid (e.g., hot water) using solar energy, and the use of such vaporous working fluid and/or hot working fluid. Hence, in the disclosure above and the paragraphs below, “vaporous working fluid” may be substituted for “steam,” “liquid working fluid” may be substituted for “water” or “feedwater,” and “hot working fluid” may be substituted for “hot water.” Suitable working fluids that may be used as alternatives to water in some variations may include, but are not limited to, ammonia, ammonia-water mixtures, pentane, isopentane, refrigerants, and other organic working fluids known to one of ordinary skill in the art or subsequently developed that may change phase from liquid to gas phase under the operating conditions of the solar vaporous working fluid generator.

This disclosure is illustrative and not limiting. Further modifications will be apparent to one skilled in the art in light of this disclosure and are intended to fall within the scope of the appended paragraphs. For example, power plants as described herein may further comprise components in addition to those shown, e.g., reservoirs, valves, and other devices for accommodating and controlling the flow of fluid through the power plant. The operation of the power plants may be controlled by a controller, such as a computer or other processing device, and may be facilitated by various monitoring systems to monitor, for example, temperature, pressure, and flow rate at various positions throughout the power plants. One of ordinary skill in the art would appreciate that various other components useful in operating and/or maintaining the power plants may be included, and need not be described herein. All publications and patent applications cited in the specification are incorporated herein by reference in their entirety as if each individual publication or patent application were specifically and individually put forth herein.

What is claimed is:

1. A method of operating a power plant, the method comprising:
(a) generating at least hot water and/or steam using solar energy;
(b) driving a first turbine using a fluid having energy obtained from a main energy source other than solar energy, and
(c) using at least a portion of the hot water and/or steam generated using solar energy as an auxiliary energy input to drive the first turbine.

2. A method according to claim 1, the method further comprising
(d) driving a solar steam turbine with at least a portion of steam generated using solar energy; and
(e) when the steam driving the solar steam turbine reaches or exceeds the normal operating capacity of the solar steam turbine, using at least a portion of the excess steam generated using solar energy as the auxiliary energy input for the operational step for driving the first turbine.

3. A method according to claim 2 wherein the first turbine is a steam turbine, and wherein the fluid driving the first turbine comprises steam heated using an energy source other than solar energy.

4. A method according to claim 3, wherein the operational step (c) of using at least a portion of the hot water and/or steam generated using solar energy as an auxiliary energy input to drive the first turbine comprises preheating feedwater for said steam heated using an energy source other than solar energy with at least a portion of the excess steam generated with solar energy.

5. A method according to claim 3 wherein the operational step (b) for driving the first turbine comprises mixing said at least a portion of the excess steam of the steam generated using solar energy with a portion of the steam generated using an energy source other than solar energy for driving the first turbine.

6. A method according to claim 2 and further comprising
extracting from the solar steam turbine a portion of the steam driving the solar steam turbine;
preheating, with the extracted steam, feedwater from which is generated at least a portion of the steam driving the solar steam turbine; and
when the steam driving the solar steam turbine reaches or exceeds the normal operating capacity of the solar steam turbine, reducing the amount of steam extracted from the solar steam turbine for preheating feedwater.

7. A method according to claim 1, wherein the operational step (a) of generating hot water and/or steam using solar energy comprises heating water with concentrated solar radiation to generate the hot water and/or steam.

8. A method according to claim 1, wherein the operational step of generating hot water and/or steam using solar energy comprises:
heating a heat transfer fluid with solar energy, and
transferring heat from the heat transfer fluid to water to generate the hot water and/or steam.

9. A method according to claim 3 wherein the step of generating steam using an energy source other than solar energy comprises generating said steam using hot exhaust from a combustion turbine.

10. A method according to claim 1, the method further comprising:
preheating a fuel using at least a portion of the hot water and/or steam generated by using solar energy; and
combusting the preheated fuel in a combustion turbine.

11. A method according to claim 10 and comprising using at least a portion of the hot water and/or steam to preheat at least a portion of the fuel prior to combusting the fuel in the combustion turbine when the steam generated by using solar energy is insufficient to drive the solar steam turbine.

12. A power plant for implementing a method according to claim 1 comprising:
a solar steam and/or hot water generator configured to heat the steam and/or water using solar energy;
a first turbine in fluid communication with and driven by a fluid heated by a main energy source other than solar energy;
a fluid coupling connecting the solar steam and/or hot water generator with said first turbine to transfer hot water and/or steam generated using solar energy as an auxiliary energy input source for the first turbine.

13. A power plant according to claim 12 wherein the first turbine is a steam turbine and wherein the power plant further comprises
a solar steam turbine in fluid communication with the solar steam generator to receive steam therefrom;
a second steam generator which uses the main energy source other than solar energy, the first turbine being driven by steam generated by the second steam generator using an energy source other than solar energy;
a feedwater preheater coupled to and in fluid communication with
the solar steam generator to receive steam from the solar steam generator, and
the second steam generator to provide the second steam generator with feedwater heated by the steam received from the solar steam generator; and
a flow controller that increases the flow of steam from the solar steam generator to the feedwater preheater when the steam driving the solar steam turbine reaches or exceeds the normal operating capacity of the solar steam turbine.

14. A power plant according to claim 13 comprising:
a second feedwater preheater coupled to and in fluid communication with
the solar steam turbine to receive steam extracted from the solar steam turbine and
the solar steam generator to provide the solar steam generator with feedwater heated by the extracted steam; and
a steam extraction flow controller that decreases the flow of extracted steam from the solar steam turbine to the second feedwater preheater when the steam driving the solar steam turbine reaches or exceeds the normal operating capacity of the solar steam turbine.

15. A power plant according to claim 13 wherein the power plant further comprises:
a combustion turbine;
a heat recovery steam generator that generates steam using hot exhaust from the combustion turbine and is coupled to and in fluid communication with the solar steam generator to receive steam from the solar steam generator and mix said steam with (a) steam generated using the hot exhaust, with (b) feedwater from which steam is generated using the hot exhaust, or with both;
the first steam turbine being driven by the heat recovery steam generator.

16. A power plant according to claim 12 wherein the first turbine is a combustion turbine, said power plant further comprising:
a fuel preheater coupled to and in fluid communication with
the solar steam and/or hot water generator to receive hot water and/or steam, and
the combustion turbine to provide fuel preheated with the hot water and/or steam.

17. A power plant according to claim 16 further comprising a solar steam turbine driven by steam generated by the solar steam and/or hot water generator.

18. A power plant according to claim 17 comprising a flow controller that, when the steam generated by the solar steam and/or hot water generator and is insufficient to drive the solar steam turbine, increases the flow of hot water, steam, or hot water and steam generated by the solar steam and/or hot water generator to the fuel preheater.

19. A power plant according to claim 17 and further comprising a flow controller that, when the steam generated by the solar steam and/or hot water generator and driving the solar steam turbine reaches or exceeds the normal operating capacity of the steam turbine, increases the flow of hot water, steam, or hot water and steam generated by the solar steam and/or hot water generator to the fuel preheater.

20. A power plant according to claim 17 and further comprising
a feedwater preheater coupled to and in fluid communication with
the steam turbine to receive steam extracted from the solar steam turbine and
the solar hot water and steam generator to provide feedwater heated by the extracted steam; and
a steam extraction flow controller that decreases the flow of extracted steam from the solar steam turbine to the feedwater preheater when the steam generated by the solar steam and/or hot water generator and driving the solar steam turbine reaches or exceeds the normal operating capacity of the solar steam turbine.

21. A power plant according to claim 17 and further comprising
a heat recovery steam generator that generates steam using hot exhaust from the combustion turbine and is coupled to and in fluid communication with
the solar hot water and steam generator to receive steam from the solar hot water and steam generator and mix it with steam generated using the hot exhaust,
feedwater from which steam is generated using the hot exhaust, or
both;
a second steam turbine driven by steam generated by the heat recovery steam generator; and
a flow controller that, when the steam driving the solar steam turbine reaches or exceeds the normal operating capacity of the solar steam turbine, increases the flow of steam from the solar steam and/or hot water generator to the heat recovery steam generator.
